(19) United States
(12) Patent Application Publication
(10) Pub. No.: US 2021/0156514 A1
(43) Pub. Date: May 27, 2021

(54) BALL MOUNT

(71) Applicant: Dreem LLC (a Wyoming LLC), Sheridan, WY (US)

(72) Inventors: Jeromi K. Stewart, West Linn, OR (US); Rasmus Henning Toerper, Hamburg (DE); Claudius Strack, Hamburg (DE)

(73) Assignee: Dreem LLC (a Wyoming LLC), Sheridan, WY (US)

(21) Appl. No.: 17/105,424

(22) Filed: Nov. 25, 2020

Related U.S. Application Data
(60) Provisional application No. 62/940,045, filed on Nov. 25, 2019.

(51) Int. Cl. F16M 13/02; F16C 11/06; F16B 1/00; F16B 2/00

(52) U.S. Cl. CPC F16M 13/022; F16C 11/06; F16B 2001/0035; F16B 2/005; F16B 1/00

(57) ABSTRACT

There is a magnetic mount assembly, comprising: a ball, including a ferromagnetic core and a friction layer bonded to an exterior surface of the ferromagnetic core; and a first magnetic mount body, having a flat front face and a concave rear face opposite the flat front face, wherein the rear face is shaped to receive curvature of the ball.

### CROSS-REFERENCE TO RELATED APPLICATIONS

This invention claims priority, under 35 U.S.C. § 120, to the U.S. Provisional Patent Application No. 62/940,045 by Stewart el al. filed on 25 Nov. 2019 which is incorporated by reference herein in its entirety.

### FIELD OF THE INVENTION

The present invention relates to mounts, specifically magnetic ball mounts.

### DESCRIPTION OF THE RELATED ART

Mounts are used to couple objects to surfaces and/or other objects for convenience, stability, etc. Some mounts are fixedly coupled to either the objects themselves or to the surfaces to which the object may be attached and are sometimes called hard mounts or hard points. Others are selectably couplable to the objects and/or surfaces such that they may be attached and detached as desired.

Mounts are often used with mobile electronic devices, such as but not limited to smart phones, GPS devices, tablets, dumb terminals, and the like. The mounts may couple the devices to surfaces (e.g. table tops, refrigerator doors, vehicle dashboards), to other objects (e.g. tripods, computer monitors), and/or to body parts of individuals (e.g. hand, head, shoulder). There the device may be utilized as desired until it should be relocated. Then the mount may be relocated and/or reconfigured or swapped out to allow for relocation of the device.

Mounts may use various coupling structures in order to couple to locations as desired, such as but not limited to clamps, clips, magnets, snaps, ties, wraps, friction fittings, screws, bolts, nails, and the like and combinations thereof. Mounts may also include articulable structures to allow for the mounted object to be positioned and/or oriented within the limits of the articulating structure, thereby providing a more fine control over the position and orientation beyond what is achieved on initial mounting thereof with the mount. Such articulable structures may include, but are not limited to, arms, hinges, pivots, rotating bodies, slides, tongue-and-groove structures, and bendable/elastically deformable portions, and the like and combinations thereof.

Ball mounts include one or more balls and are sometimes magnetically coupled to coupling structures that are able to couple to one or more objects surfaces. Ball mounts provide a high degree of freedom of motion for the object to be mounted once it is mounted, especially when using magnetic coupling. As a non-limiting example, where a pure magnetic coupling is used between the hall and the coupling member, the coupling member can generally rotate 360 degrees (or more) which allows for complete rotational freedom about a single axis for the mounted object.

The inventions heretofore known suffer from a number of disadvantages, including but not limited to: being inconvenient, not being reliable, being dangerous, not being durable, being prone to rust, degrading after a short period of time, not being comfortable to use, not being easy to use, being too heavy, being difficult to carry, and/or not being portable.

What is needed is a ball mount that solves one or more of the problems described herein and/or one or more problems that may come to the attention of one skilled in the art upon becoming familiar with this specification.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a side elevational view of a ball mount in an orthogonal configuration, according to one embodiment of the invention;

FIG. 2 is a perspective exploded view of a ball mount in a parallel configuration, according to one embodiment of the invention;

FIG. 3 is a cross-sectional side elevational view of a ball mount in a parallel configuration, according to one embodiment of the invention;

FIG. 4 is a partial side elevational section view of a ball mount, according to one embodiment of the invention;

FIG. 5 is a cross-sectional side elevational view of a ball mount in an orthogonal configuration, according to one embodiment of the invention;

FIG. 6 is a perspective exploded view of a bar-style ball mount in a parallel configuration, according to one embodiment of the invention;

FIG. 7 is a cross-sectional side elevational section view of a bar-style ball mount in a parallel configuration, according to one embodiment of the invention; and

FIG. 8 is top perspective view of a bar-style ball mount in a parallel configuration, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not Ire present in all embodiments of the invention.

These features and advantages of the present invention will become more fully apparent from the following description and appended claims or may be learned by the practice of the invention as set forth hereinafter.

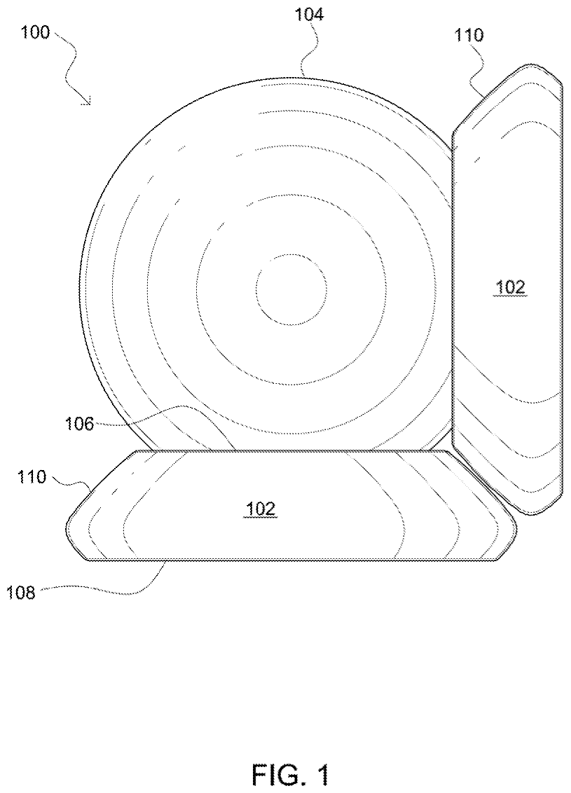

FIG. 1 is a side elevational view of a ball mount in an orthogonal configuration, according to one embodiment of the invention. There is shown a ball mount 100 including a pair of flat ring mounts 102 magnetically coupled to a coated ball 104. The flat ring mounts 102 may include a rear face 106 and/or a front face 108, as well as a beveled face 110. The rear face 106 and/or front face 108 may incorporate a high friction material.

In the illustrated embodiment, the flat ring mount 102 is frustoconical, with the rear face 106 being concave in order to receive the curvature of the coated ball 104, while the front face 108 is flat in order to provide stability as well as a larger surface area for mounting. The beveled faces 110 are also designed to create an acute angle relative to the front face 108.

The flat ring mounts 102 have an effective radius that is small enough to allow them to be close enough to each other without interfering with each other in order to allow for a small angle between the flat ring mounts 102. Wherein the flat ring mounts 102 include beveled faces 110, with the illustrated embodiment showing the front face 108 having a larger diameter than the rear face 106, the flat ring mounts 102 are able to get closer than if they had non-beveled faces. Wherein a difference between the maximum radius of the flat ring mounts 102 and the coated ball 104 is small, that also permits a closer fit between the flat ring mounts 102 and therefore results in allowing for a smaller angle therebetween. It may be that a difference between the maximum radius of the flat ring mounts 102 and the coated ball 104 is less than about one or more of 15%, 14%, 13%, 12%, 11%, 10%, 9%, 8%, 7%, 6%, 5%, 4%, 3%, 2%, or 1% of the maximum radius of the ball.

It may be that the beveled faces 110 are beveled at approximately 45 degrees with respect to the front face 108 of the ring mount 102. Such may be between one or more of about 35, 40, 45, 50, and 55 degrees.

In the illustrated embodiment, the ball mount 100 is shown with two flat ring mounts 102, which are identical to one another. However, in other non-limiting embodiments, the flat ring mounts 102 and the pieces that make up the flat ring mounts 102 may have opposite polarities, different shapes, structures, cores, housings, magnets, and number and/or arrangement of magnets. In one non-limiting embodiment, the ball mount 100 includes only one flat ring mount 102, while in other non-limiting embodiments, the ball mount 100 includes three or more flat ring mounts 102.

The flat ring mounts 102 may magnetically couple to the coated ball 104, and may also magnetically couple to another object/surface, as desired, such as but not limited to a metal smartphone case, a housing for a tablet PC, a ferromagnetic mounting surface, or a ferromagnetic table/door/wall/etc. Additionally, a user may simply couple one of the flat ring mounts 102 to a smartphone case and leave the other uncoupled (except to the coated ball 104) and then may place the ball between a pair of adjacent fingers, thereby using the ball mount 100 to mount their phone to their hand.

In one non-limiting embodiment, there is a magnetic mounting system that can be used in one's car or other places. It allows one to attach a device (e.g. phone, tablet) and mount it anywhere that you have a metal surface, and if one does not have a metal surface one can use a mounting plate. It is portable. It may be used as a stand for a coupled device. It includes narrow flat ring mounts 102 with beveled faces 104 that can rotate across the surface of the ball, with respect to each other up to 90 degrees so one can use it to position their device conveniently. It may be an “anywhere” magnetic mounting system.

There may be multiple versions and/or variations, including but not limited to 1) a mount that (may be permanently) attaches to a surface and has a curved surface that attaches to a sliding mount and the curved surface has a friction layer (this version is not a complete sphere because it has one side that attaches to a surface and it may have a flat surface, may be fixedly coupled to a flat base, or may have a hollowed out coated ball 104 designed to accept a mounting arm or other device), and 2) two sliding magnetic mounts shaped to allow for approximately 90 degree positioning between the two and a coated ball 104 magnetically coupled between.

It may be that there are three components to an embodiment of the invention, including: a hollow sphere that may be about 2 mm thick made from iron (or another ferromagnetic material) and a thin layer of silicone adhered to the outside surface of the ball; and one or more a slidable mounts with a custom shaped ring magnet that is shaped to match up with the hollow sphere where the surface of the ring magnet comes into contact with the curved surface of the sphere.

It may be that there is a silicone layer on the magnet that coats all surfaces of the slidable mount except for the part of the magnet that touches the sphere. The magnet surface that touches the sphere may be sculpted to match with the sphere. The ring magnet magnetically couples to a magnetically active plate (this may just be the phone/tablet itself or may be separate from that) that couples to the device via a coupling structure (e.g. adhesive, friction fit, screws). The sphere and/or one or more of the slidable mounts may include an attachment structure (e.g. clamp, clip, screw, threaded hole, bolt, adhesive) for attaching to another structure/object, such as but not limited to mounting to a vehicle dashboard.

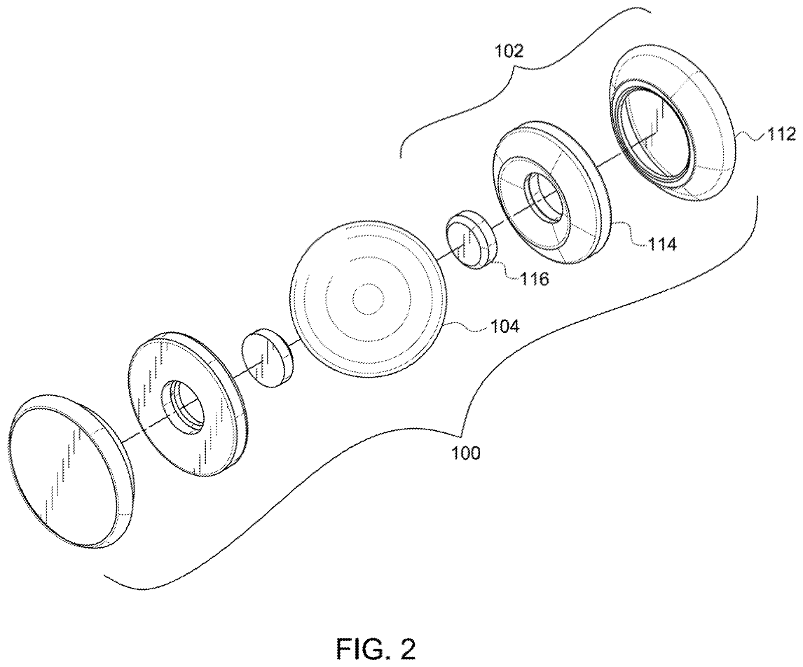

FIG. 2 is a perspective exploded view of a ball mount 100 in a parallel configuration, according to one embodiment of the invention. Flat ring mount 102 includes a housing 112, a single ring magnet 114. and a ferromagnetic core 116.

The housing 112 may be made of a rigid material, examples of which may include aluminum, steel, or hard plastics. However, the housing 112 may also be made of a flexible material, examples of which may include silicone, rubber, or soft plastics. In some embodiments, the housing 112 is made of both rigid and flexible materials, which may be separable from one another. The housing 112 may also be made of a high friction material which is bonded to an exterior surface of the ring magnet 114 and/or the ferromagnetic core 116.

The ring magnet 114 is mostly enclosed in the housing 112. The housing 112 does not cover any part of the ring magnet 114 that magnetically couples directly with the coated ball 104 and thereby the ring magnets 114 each engage directly with the coated ball 104 without any other material on the ring mount 102 disposed therebetween. In one non-limiting embodiment, the ring magnet 114 is a neodymium magnet with a matte nickel finish in order to allow for one or more adhesives to properly bond to the ring magnet 114.

The ferromagnetic core 116 is surrounded by the ring magnet 114. In the illustrated embodiment, the ferromagnetic core 116 is cylindrically shaped, however in other non-limiting embodiments, the ferromagnetic core 116 may be any number of shapes. The ferromagnetic core 116 is also not fixed within the flat ring mount 102, rather it is floating, and is allowed to slide or spin freely between the ring magnet 114 and relative to the housing 112, however in other non-limiting embodiments, the ferromagnetic core 116 may be fixed inside the fiat ring mount 102 by being directly affixed to or otherwise contained by the ring magnet 114 and/or the housing 112.

As a non-limiting example, while the illustrated flat ring mounts 102 have a circular profile from a top view, other profile shapes may exist in the various ring mounts 102, including but not limited to rectangular, ovoid, and irregular.

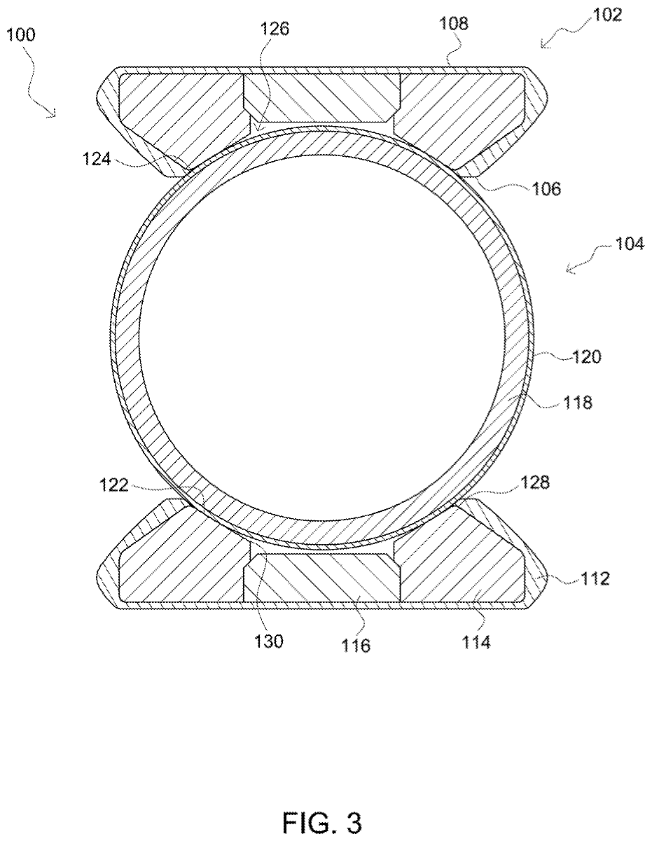

FIG. 3 is a cross-sectional side elevational view of a ball mount 100 in a parallel configuration, according to one embodiment of the invention. The illustrated coated ball 104 includes a ferromagnetic spherical body 118 that is coated with a friction enhancing material 120. The ferromagnetic spherical body 118 is generally hollow in order to reduce the total weight and required material of the ball mount 104. The body is thick enough to provide a desired strength and heft.

The friction enhancing material 120 helps to make sure that the flat ring mount 102 stays in position once a particular configuration is selected. Generally, the friction enhancing material 120 will include one or more of the following: silicone, rubber, and/or plastic and may be present as a coating, a wrapped body, a webbing, and the like or combinations thereof. In one non-limiting embodiment, the friction enhancing material 120 is adhesively bonded to the ferromagnetic sphere 118.

The ferromagnetic sphere 118 will generally have a smooth exterior with a friction co-efficient that reflects a lower friction between the surface of the ferromagnetic sphere 118 and the ring magnets 114 of the flat ring mounts 102 when compared to the friction between the coating 112 and the magnets 114 of the ring mount(s) 102.

In the illustrated embodiment, the ferromagnetic core 116 and the ring magnet 114 are sized and shaped so that the ferromagnetic core 116 is restrained from sliding out of the flat ring mount 102 by the ring magnet 114 on one side, and the housing 112 on the other side. Additionally, the ferromagnetic core 116 is sized and shaped so that the friction enhancing material 120 does not contact the ferromagnetic core 116 when the flat ring mount 102 is magnetically attached to the coated ball 104.

In the illustrated embodiment, ring magnet 114 has a beveled surface 122 that mates with the curvature of the coated hall 104 The friction enhancing material 120 is generally of a softer, more elastic material, and protects the ring magnet 116 and protects surfaces/objects from the ring magnet 116. Looking closely at the physical structure of the coated ball 104 in relation to the beveled surface 122, one notes that the point of contact 124 between the curvature of the coated ball 104 and the flatness of the beveled surface 122 is at a point on the beveled surface that is at or near a far exterior edge 128 of the beveled surface 122.

One can also see that there is an air gap 126 between the curvature of the coated ball 104 and the flatness of the beveled surface 122 near the interior edge 130 of the beveled surface 122. This allows for a higher surface area of contact between the ball 104 and the mount 102 (because the effective circumference of that region is larger than the effective circumference of other contact regions limiter inward), which creates a stronger coupling thereto, which is especially resistant to angular torsion causing slippage therebetween. As a non-limiting example, this would allow for mounting of a rectangular smartphone to a mount in a way that was not symmetrical and thereby induced a force differential/leverage at the mount, which would bias the mount 102 towards rotation with respect to the ball 104, but the stronger contact could prevent that rotation, which would keep the smartphone positioned in place instead of allowing the phone to drift downward or rotate in ways that the user did not intend. This is a common problem among magnetic mounts, as they tend to be very vulnerable to rotational/angular torsion causing rotation of the mount body.

In one non-limiting embodiment that is structurally simpler than the illustrated flat ring mount 102, the ring mount 102 is of a single composite material (e.g. the soft and flexible refrigerator magnets) that is elastic and soft (e.g. rubber, plastic, silicone) with embedded magnetic particles distributed therethrough that, together, generate a substantially uniform magnetic field.

The rear face 108 of flat ring mount 102 may include threaded holes, hook mounts, hooks, or other structures for mounting to an object/surface. It may be substantially flat so as to form a flat surface on which the entire ball mount may be supported on a surface. It may be that the housing 112 is sufficiently thin that the single illustrated ring magnet provides magnetic coupling for both the front side 108 and the back side 106.

In some non-limiting embodiments, there is a mount aperture through a bottom of the ferromagnetic sphere 118 through which a mounting pin may be disposed (e.g. at a top of a tripod, from a mounting plate coupled to a dashboard of a car). The mount aperture may include a textured interior or otherwise be something other than a simple cylinder which may provide one or more cavities into which spring-loaded pins of a mounting pin may be disposed to snap lock the mounting pin into the ball. The flat ring mount still allows for highly configurable positioning of an attached object (e.g. smartphone) while the mount aperture provides a very stable connection.

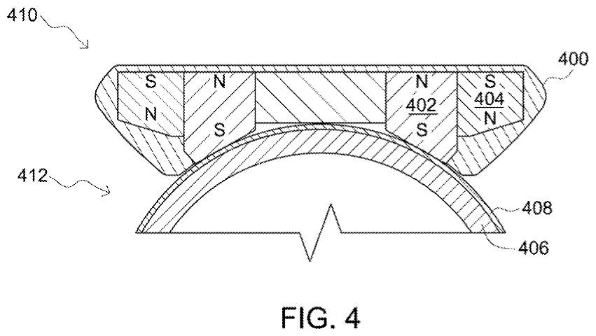

FIG. 4 is a partial side elevational section view of a ball mount, according to one embodiment of the invention. In this embodiment, there are two ring magnets 402, 404 in a concentric array which are held in place by a housing 400. Advantageously, such an array of magnets creates a significantly firmer magnetic coupling between the mount 410 and a desired mounting surface.

The illustrated concentric array of ring magnets 402, 404 have their respective polarity arranged in relation to each other such that they are opposite to each other (i.e. opposite poles facing the same direction as each other, see the illustrated N and S identifying the poles thereof). Such a configuration of ring magnets 402, 404 induces a magnetic attraction, one to one another, which creates a stronger magnetic pull on ferromagnetic sphere 406 when compared to a single ring magnet of identical shape/size, therefore pressing friction enhancing material 408 to mount 410 more firmly which reduces slipping.

In other non-limiting embodiments, there may be two or more ring magnets arranged radially or linearly (e.g. stacked or side-by-side) instead of being arranged in a concentric array. Such arrangements may also include alternating polarity, thereby inducing stronger attractive forces to the ball 412. Such arrangements may also form part of the housing and/or may induce a ferromagnetic housing to be strongly coupled to the magnets, thereby reducing a need for a full sleeve of housing and/or for coupling structures to hold various faces of the housing together.

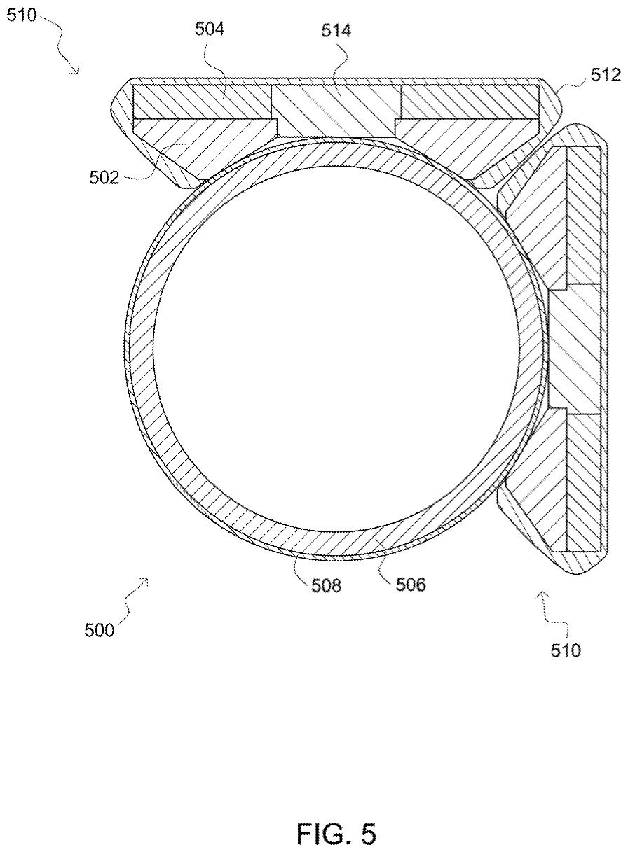

FIG. 5 is a cross-sectional side elevational view of a ball mount in an orthogonal configuration, according to one embodiment of the invention. The illustrated ball mount 500 advantageously allows for smaller/thinner ring magnets to be used in the construction thereof. Further, the illustrated ring magnets 502, 504 have differing internal hole diameters, which form a trap structure that mates with the ferromagnetic core 514 and thereby prevents the same from sliding out.

The illustrated ball 506 is a hollow spherical body of a magnetically attractive material and includes a friction inducing coating 508 (e.g. silicone, rubber, plastic). Accordingly, the ball 506 is magnetically couplable to each of the illustrated mounts 510. Those mounts 510 may then slide and/or rotate in relation to the sphere 506 while being held thereto.

In the illustrated embodiment, two ring magnets 502, 504 within each mount 510 are stacked on top of each other. Those two stacked ring magnets 502, 504 hold the illustrated ferromagnetic cores 514 in place, with the ring magnets 502, 504 themselves being held into place by the housing 512.

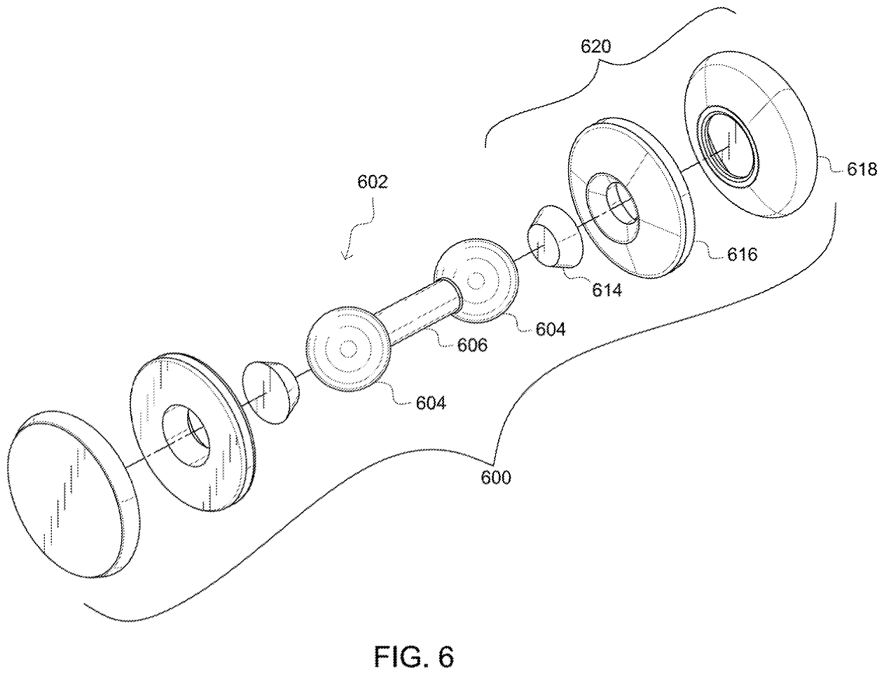

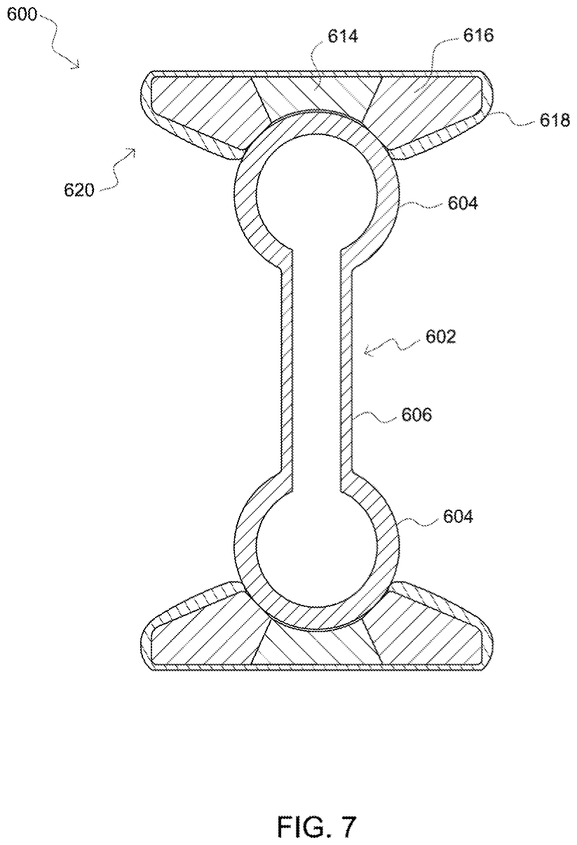

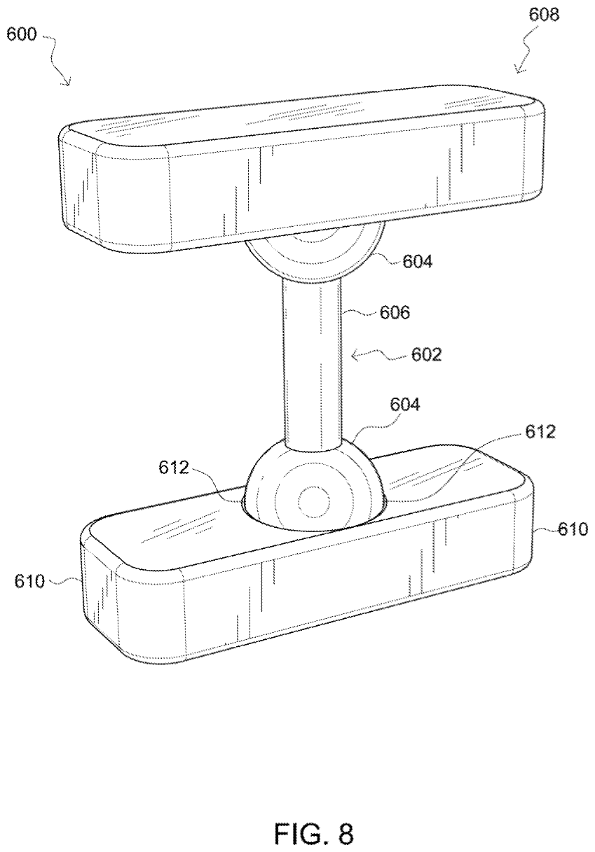

FIGS. 6-8 are various views of a bar-style ball mount, according to one embodiment of the invention. In particular, FIG. 6 is a perspective exploded view of a bar-style ball mount in a parallel configuration. FIG. 7 is a cross-sectional side elevational section view of a bar-style ball mount in a parallel configuration, and FIG. 8 is top perspective view of a bar-style ball mount in a parallel configuration, each according to one embodiment of the invention. In the illustrated embodiment, the illustrated “ball” 602 is shaped like a dumbbell having two ball-shaped ends 604 that each allows the user to position the object mounted to ball mount 600 in a way that might not be possible with previous illustrated embodiments. In particular, while the ball mount in FIGS. 1-3 is able to achieve an orthogonal configuration having an angle between the two mounts, the dumbbell-shaped ball in FIGS. 6-8 is able to achieve even smaller angular relationships between the two mounts 620.

The illustrated dumbbell-shaped ball 602 is hollow to save on material costs and weight. It includes a shaft 606 disposed between a pair of spherical ends 604 that are shaped to match with the inset portions of the illustrated mounts. The spherical ends 604 are of a magnetically attractive material, whereby the ends 604 are magnetically attracted to the rectangular mounts 608. While the illustrated dumbbell-shaped ball 602 is not coated, it is understood that an embodiment of such may be coated.

The illustrated mounts 608 are shaped like rounded rectangles at their far ends 610, with curved insets in the middle of their near ends 612, into which the ends 604 of the dumbbell-shaped ball nest 602. The illustrated ferromagnetic core 614 in each of the mounts 620 is frustoconical and inset into the ring magnets 616 of the flat ring mounts 620 to thereby prevent it front sliding out of ring magnet 616. Each mount includes an exterior coating 618 that serves to protect (e.g. from impact, shock, foreign materials) the magnet 616 and the ferromagnetic core 614 and also to help hold the components thereof together.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

As a non-limiting example, there may be embodiments with multiple ferromagnetic spheres attached to one another in order to allow for multiple devices to be mounted to a singular ball mount for a user who wishes to mount multiple devices and does not have multiple mounting locations or has space constraints. In other examples, where there is an elongated “ball” (such as, but not limited to the dumbbell embodiment), the “ball” may contain flexible material or a joint to allow the user to bend the “ball” and select a custom mounting position which a static ball mount would not be optimal for the user or simply might not fit.

Further, it may be that the frictional layer present between the ferromagnetic sphere and magnet of the present invention is not directly attached to the ferromagnetic sphere, rather the frictional layer is instead attached to the magnet. It may instead be that the frictional layer is not attached to either the magnet or the ferromagnetic sphere, rather the frictional layer is a separate piece that is not adhered, rather held in place between the ferromagnetic sphere and magnet by the magnetic attraction between the two. This would easily allow for a worn-out frictional layer to be cheaply and easily replaced without the need to repurchase the entire ball mount or pieces thereof.

Thus, while the present invention has been fully described above with particularity and detail in connection with what is presently deemed to be the most practical and preferred embodiment of the invention, it will be apparent to those of ordinary skill in the an that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A magnetic mount assembly, comprising:
a. a ball, including:
i. a ferromagnetic core; and
ii. a friction layer bonded to an exterior surface of the ferromagnetic core; and
b. a first magnetic mount body, having:
i. a flat front face; and
ii. a concave rear face opposite the flat front face, wherein the rear face is shaped to receive curvature of the ball.

2. The magnetic mount assembly of claim 1, further comprising a second magnetic mount body having a flat front face and a concave rear face opposite the flat front face, wherein the rear face is shaped to receive curvature of the ball.

3. The magnetic mount assembly of claim 1, wherein the first magnetic mount body further includes a side coupled between the front face and the rear face wherein an angle between the front face and the side is acute.

4. The magnetic mount assembly of claim 1, wherein the ferromagnetic core is a hollow sphere.

5. The magnetic mount assembly of claim 1, wherein the friction layer is bonded to the ferromagnetic core via an adhesive layer.

6. The magnetic mount assembly of claim 1, wherein the first magnetic body mount is frustoconical.

7. The magnetic mount assembly of claim 6, wherein the front face has a larger diameter than the rear face.

8. The magnetic mount assembly of claim 1, wherein the first magnetic mount body further includes a single ring magnet with a friction coating bonded to an exterior surface of the ring magnet.

9. The magnetic mount assembly of claim 1, wherein the first magnetic mount body includes two ring magnets arranged concentrically in relation to each other.

10. The magnetic mount assembly of claim 1, wherein the first magnetic mount body includes an elastic housing enclosing:
a. a floating ferromagnetic core that is surrounded by
b. a ring magnet.

11. A magnetic mount assembly, comprising:
a. a ball, including:
i. a ferromagnetic core; and
ii. a friction layer bonded to an exterior surface of the ferromagnetic core; and
b. a first frustoconical magnetic mount body magnetically coupled to the ball, having:
i. a flat front face; and
ii. a concave rear face opposite the flat from face, wherein the rear face is shaped to receive curvature of the ball.

12. The magnetic mount assembly of claim 11, further comprising a second frustoconical magnetic mount body having a flat front face and a concave rear face opposite the flat front face, wherein the rear face is shaped to receive curvature of the ball.

13. The magnetic mount assembly of claim 12, wherein the first magnetic mount body further includes a side coupled between the front face and the rear face wherein an angle between the front face and the side is acute.

14. The magnetic mount assembly of claim 13, wherein the friction layer is bonded to the ferromagnetic core via an adhesive layer.

15. The magnetic mount assembly of claim 14, wherein the ferromagnetic core is a hollow sphere.

16. The magnetic mount assembly of claim 15, wherein the front face has a larger diameter than the rear face.

17. The magnetic mount assembly of claim 16, wherein the first magnetic mount body further includes a single ring magnet with a friction coating bonded to an exterior surface of the ring magnet.

18. The magnetic mount assembly of claim 17, wherein the first magnetic mount body does not include a ferromagnetic housing.

19. The magnetic mount assembly of claim 18, wherein the first magnetic mount body includes a ferromagnetic core that is surrounded by one or more magnets in the magnetic mount body.

20. A magnetic mount assembly, comprising:
a. a ball, including:
i. a ferromagnetic core; and
ii. a friction layer bonded to an exterior surface of the ferromagnetic core via an adhesive layer; and
b. a first and second frustoconical magnetic mount body, each having:
i. a flat front face;
ii. a concave rear face opposite the flat front face, wherein the rear face is shaped to receive curvature of the ball and the front face has a larger diameter than a diameter of the rear face;
iii. a side coupled between the front face and the rear face wherein an angle between the front face and the side is acute; and
iv. a ring magnet enclosed within an elastic housing, the ring magnet surrounding a floating ferromagnetic core.
